(19) United States
(12) Patent Application Publication
(10) Pub. No.: US 2005/0251868 A1
(43) Pub. Date: Nov. 10, 2005

(54) Theft deterrence method and system

(75) Inventor: J. Michael James, Pleasanton, CA (US)

Correspondence Address: MANATT PHELPS AND PHILLIPS;ROBERT D. BECKER, 1001 PAGE MILL ROAD, BUILDING 2, PALO ALTO, CA, 94304, US

(73) Assignee: PORTRAIT DISPLAYS, INC., Pleasanton, CA (US)

(21) Appl. No.: 10/840,467

(22) Filed: May 5, 2004

(51) Int. Cl. H04L 9/00

(52) U.S. Cl. 726/35

(57) ABSTRACT

A computer system includes a theft deterrence program installed on a monitor (12) and a host computer (11). The theft deterrence program is in a deactivated state as long as the monitor (12) is connected to the host computer (11) and to a power source. Once the monitor (12) is disconnected from the power source and the host computer (11), the theft deterrence program enters an activated state when the monitor (12) powers up again. If not deactivated within a predetermined time period, the theft deterrence program enters a theft deterrence mode that disables or significantly deteriorates the function of the monitor (12). Connecting the monitor (12) to an authorized host computer or entering a PIN before the countdown time elapses can deactivate the theft deterrence program. The deactivated theft deterrence program allows the normal operation of the monitor (12).

### FIELD OF THE INVENTION

The present invention relates, in general, to theft deterrence and, more specifically, to deterring the theft of electronics and computer devices.

### BACKGROUND OF THE INVENTION

As computers and other electronic devices become more common in society, the theft of such devices also increases. For example, flat panel displays, e.g., liquid crystal display (LCD) monitors, are very susceptible to theft because of their high price and light weight and compact size. Traditional theft deterrence mechanisms, e.g., locks, inscriptions of the owner's names, etc., are typically visible and can often be easily removed or otherwise defeated. In addition, they often hinder the ease of use of the protected devices by their rightful users and/or reduce the value of the protected devices to their owners.

Accordingly, it would be advantageous to have a theft deterrence system and method that effectively deters the unauthorized move of a protected device. It is desirable for the theft deterrence system to be easy to implement and not hinder the use of the protected device. It is also desirable for the theft deterrence system to not affect the value of the protected device.

### BRIEF DESCRIPTION OF THE DRAWINGS

FIG. 1 illustrates a typical set up of a computer system in accordance with the present invention;

FIG. 2 illustrates a logic structure of a monitor in accordance with the present invention;

FIG. 3 illustrates a theft deterrence program indicator pane in accordance with the present invention;

FIG. 4 illustrates a theft deterrence program configuration pane in accordance with the present invention;

FIG. 5 illustrates another theft deterrence program indicator pane in accordance with the present invention;

FIG. 6 illustrates a theft deterrence program disable pane in accordance with the present invention;

FIG. 7 illustrates a theft deterrence program deactivation pane in accordance with the present invention;

FIG. 8 illustrates a theft deterrence process in accordance with the present invention; and

FIG. 9 illustrates theft deterrence labels in accordance with the present invention.

### DETAILED DESCRIPTION OF PREFERRED EMBODIMENTS

Various embodiments of the present invention are described hereinafter with reference to the drawings, in which same or related reference numerals are used to represent related elements throughout the figures. It should be noted that the figures are only intended to facilitate the description of specific embodiments of the invention. They are not intended as an exhaustive description of the invention or as a limitation on the scope of the invention. In addition, an aspect described in conjunction with a particular embodiment of the present invention is not necessarily limited to that embodiment and may be practiced in conjunction with any other embodiments of the invention.

The present invention provides a system for deterring the theft or unauthorized move of apparatus that have electronic circuit components. In accordance with embodiments of the present invention, the system deters the theft or unauthorized move of computer peripheral devices. In accordance with a specific embodiment, the system deters the theft or unauthorized move of computer monitors.

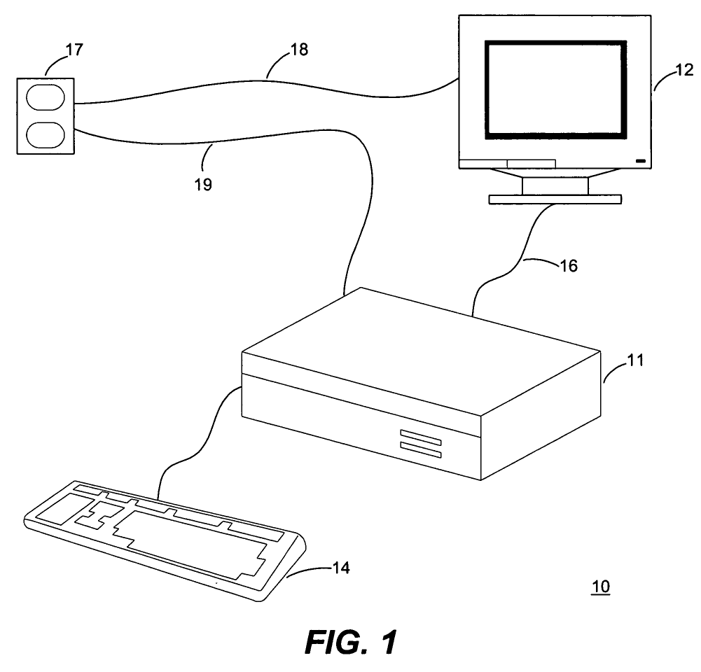

FIG. 1 illustrates a typical set up of a computer system 10. Computer system 10 includes a host computer unit 11 that may be a workstation, a desktop unit, a tower unit, etc. Computer system 10 also includes a monitor 12 and a keyboard 14 connected to host computer 11. Monitor 12 is connected to host computer 11 via a video cable 16. Monitor 12 is also coupled to a power supply outlet 17 via a power cord 18. Host computer 11 is coupled to power supply outlet 17 via a power cord 19. In an alternative arrangement, power cord 18 of monitor 12 is coupled to a power socket on host computer 11. In this arrangement, monitor 12 receives power from power supply outlet 17 via host computer 11. Computer system 10 may include other devices, e.g., printers, and may be coupled to a network, e.g., a local area network (LAN), wide area network (WAN), Ethernet, Internet, etc.

A theft deterrence system in accordance with the present invention deters the unauthorized move of monitor 12. In accordance with an embodiment of the present invention, monitor 12 is a liquid crystal display (LCD) monitor. Because of its high price, light weight, and compact size, an LCD monitor is typically more susceptible to theft than a CRT monitor. However, it should be understood that the present invention is applicable to a wide variety of computer monitors and peripherals.

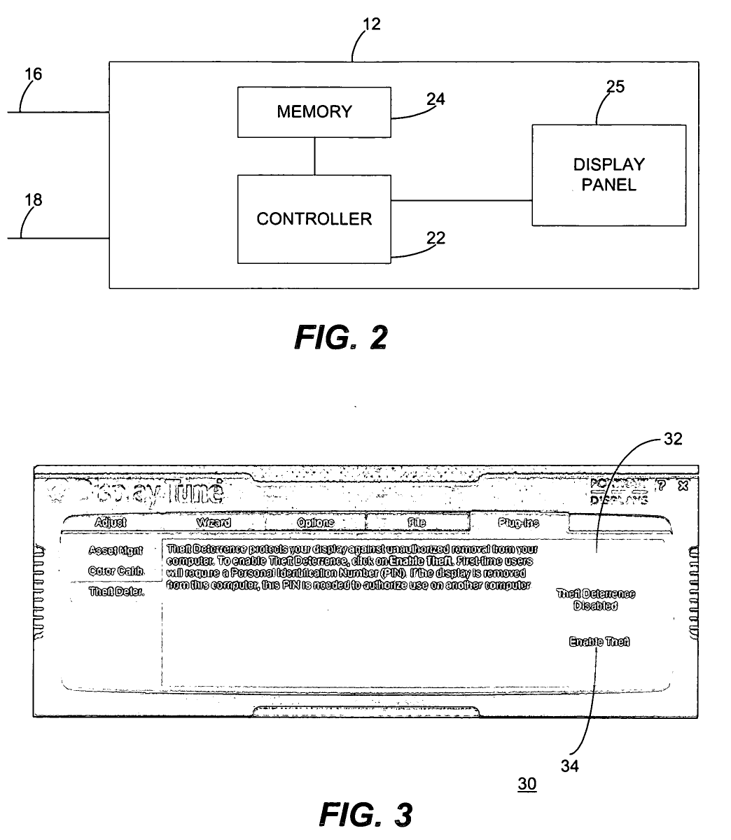

FIG. 2 is a block diagram illustrating a logic structure of monitor 12. As described above with reference to FIG. 1, monitor 12 includes video cable 16 for receiving video display signals from host computer 11 and power cord 18 for receiving electric power from power source outlet 17. FIG. 2 shows monitor 12 also including a controller 22, a memory unit 24, and a display panel 25. Memory unit 24 may include volatile and nonvolatile memory elements. In accordance with a preferred embodiment of the present invention, memory unit 24 includes at least one nonvolatile memory element. Memory unit 24 stores the programs to be executed by controller 22 for processing the video signals from host computer 11 for display on display panel 25. Controller 22 may include a digital signal processor (DSP), a microprocessor (μP), a central processing unit (CPU), etc.

In accordance with the present invention, theft deterrence of monitor 12 is achieved by installing a theft deterrence program on host computer 11 and monitor 12. The theft deterrence program may be stored on a portable storage medium, e.g., compact disc (CD), digital versatile disc (DVD), etc., and supplied to customers for installation. Computer and monitor manufacturers or vendors may preinstall the theft deterrence program or package the program with the computers and monitors. The theft deterrence program may also be downloaded from a web site via Internet or from a corporate or institution server via Intranet.

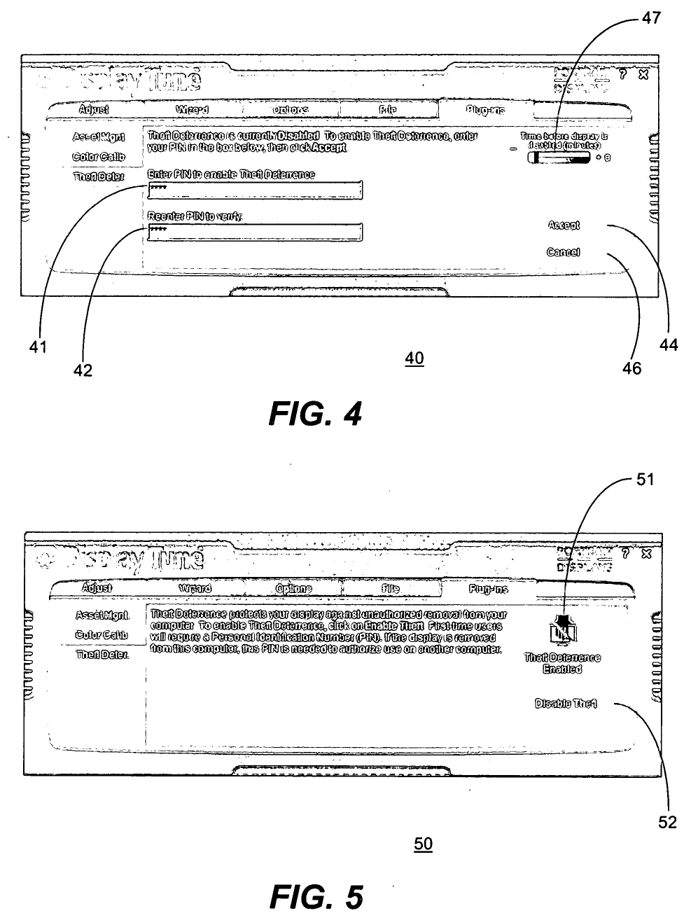

In accordance with an embodiment of the present invention, the theft deterrence program includes two subprograms, one installed on host computer 11 and another installed on monitor 12. The subprogram installed on monitor 12 is stored in memory unit 24 and executed by controller 22 in deterring the theft or unauthorized move of monitor 12. In accordance with a preferred embodiment of the present invention, the theft deterrence program is in a disabled state when installed. By way of example, FIG. 3 illustrates an indicator pane 30 displaying a plug-in tab for the theft deterrence program in accordance with an embodiment of the present invention. On indicator pane 30, an icon 32 indicates the theft deterrence program being in a disabled state. To enable the theft deterrence program, a user clicks a button 34 to bring up a theft deterrence program configuration or enabling pane 40 shown in FIG. 4. On enabling pane 40, there are two fields 41 and 42 for user to enter and reenter an authorization code, e.g., a personal identification number (PIN) or a password. The PIN or password may be numerical, alphabetical, or alphanumerical. In a specific embodiment, the PIN is a numerical code between four and nine digits. An Accept button 44 is dim until the PIN entered and reentered at fields 41 and 42 match each other. A Cancel button 46 enables the user to cancel the enabling process and return to indicator pane 30 shown in FIG. 3. A slider bar 47 allows the user to select a time duration before pane 40 closes and the theft deterrence program is shut down.

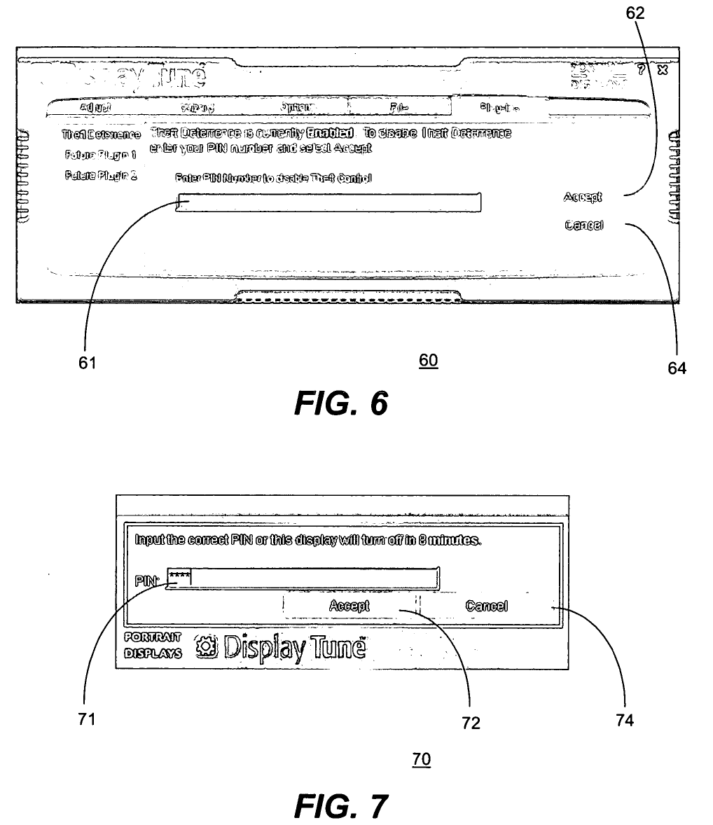

In response to entering the PIN at fields 41 and 42 and clicking Accept button 44, the theft deterrence program enters an enabled state and presents the user with another indicator pane 50 as shown in FIG. 5. On pane 50, an icon 51 indicates the enabled state of the theft deterrence program. The user can click a Disable button 52 to proceed to a theft deterrence program disabling pane 60 shown in FIG. 6. On disabling pane 60, the user can enter the PIN at a field 61 and click an Accept button 62 to disable the theft deterrence program. In response to being disabled, the theft deterrence program presents the user with indicator pane 30 shown in FIG. 3. The user can also click a Cancel button 64 to return to indicator pane 50 shown in FIG. 5 with the theft deterrence program enabled.

When enabled, the theft deterrence program deters unauthorized removal of monitor 12 from computer system 10, as shown in FIG. 1, without hindering the normal use of monitor 12 in computer system 10. In accordance with the present invention, the enabled theft deterrence program is inactive until a triggering event that implies an unauthorized move of monitor 12. By way of example, the triggering event for activating the theft deterrence program may be disconnection of monitor 12 from power source outlet 17 via power cord 18, disconnection of monitor 12 from host computer 11 via video cable 16, or both. In accordance with a preferred embodiment of the present invention, the disconnection of monitor 12 from host computer 11 and the disconnection of power cord 18 from a power source function as a triggering event and activate the theft deterrence program. The power source may be power supply outlet 17 shown in FIG. 1, a power socket on host computer 11, or the like.

Once activated, the theft deterrence program starts a time countdown. In order for monitor 12 to properly function, the theft deterrence program needs to be deactivated before the countdown ends. FIG. 7 illustrates a theft deterrence program deactivation pane 70 in accordance with an embodiment of the present invention. On deactivation pane 70, the user can enter the PIN at a field 71 and click an Accept button 72 to deactivate the theft deterrence program. In response to being deactivated, the theft deterrence program presents the user with indicator pane 50 shown in FIG. 5. The user can also click a Cancel button 74 to cancel the deactivation process.

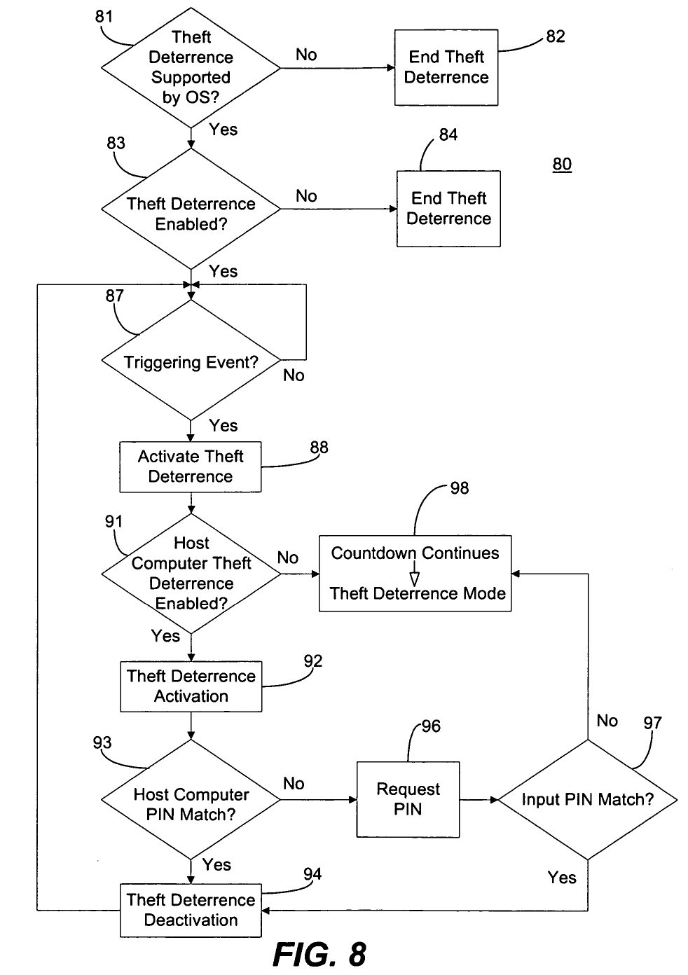

FIG. 8 is a flowchart illustrating a theft deterrence process 80 in accordance with the present invention. When the theft deterrence program is installed on computer system 10, theft deterrence process 80 determines whether the operating systems of host computer 11 and monitor 12 support the theft deterrence program in a step 81. By way of example and in accordance with a specific embodiment of the present invention, the theft deterrence program is compatible with Microsoft Windows operating systems. In accordance with various alternative embodiments, the theft deterrence program may also be compatible with Macintosh operating systems, Linux operating systems, etc. In should be noted that a theft deterrence program in accordance with the present invention may be compatible with any operating system, currently available or to be developed in the future. If the operating systems on host computer 11 and monitor 12 do not support the theft deterrence program, process 80 terminates in a step 82.

In a step 83, process 80 verifies whether the theft deterrence program is enabled. The enabling and disabling of the theft deterrence program may be achieved by following the procedures described herein above with reference to FIGS. 3, 4, 5, and 6. If the program is not enabled, process 80 terminates in a step 84.

While enabled, the theft deterrence program remains inactive until a triggering event. In accordance with a preferred embodiment of the present invention, the disconnection of video cable 16 from host computer 11 and the disconnection of power cord 18 from power source 17, as shown in FIG. 1, activate the theft deterrence program. Process 80 detects the disconnection of power cord 18 and video cable 16 in a step 87. If no disconnection is detected, the theft deterrence program remains inactive. When video cable 16 and power cord 18 are disconnected, there is no power supplied to controller 22 in monitor 12. The power down of controller 22 serves as a triggering event activating the theft deterrence program in accordance with a preferred embodiment of the present invention. It should be noted that, in accordance with the present invention, the triggering event is not limited to a power outage to controller 22 in monitor 12 and monitor 12 may include other mechanisms for detecting the triggering event.

In accordance with a specific embodiment of the present invention, controller 22 activates the theft deterrence program, in a step 88, in response to monitor 12 being connected to a host computer and powered up again. The activated theft deterrence program starts a countdown of time for a predetermined time period, e.g., thirty seconds, two minutes, five minutes, etc. In a step 91, process 80 checks if the host computer has the theft deterrence program enabled. In response, if the host computer does not have the theft deterrence program enabled, the countdown of time continues. At the end of the predetermined time period, the theft deterrence program enters a theft deterrence mode in a step 98 that either disables monitor 12 or significantly deteriorates the performance of monitor 12. In accordance with a preferred embodiment of the present invention, monitor 12 displays a message indicating monitor 12 is in the theft deterrence mode. By way of example, the message can be simply be “Theft Deterrence Mode.”

In response to the host computer having the theft deterrence program enabled, the theft deterrence program enters a theft deterrence activation state in a step 92. In the theft deterrence activation state, the countdown of time continues. Monitor 12 may display a message, e.g., “Theft Deterrence Activation,” indicating the program is activated. If a user logs into the host computer, process 80 verifies, in a step 93, whether the PIN stored in the host computer matches that stored in monitor 12. In response to matching PINs, which indicate that monitor 12 is connected to an authorized host computer, process 80 deactivates the theft deterrence program in a step 94. In response to no matching PINs, process 80 continues the time countdown and waits for the user to enter a PIN in a step 96. Monitor 12 may display a message requesting a user to enter a PIN, which functions as an authorization code. By way of example, the message can simply be “Theft Deterrence has been activated, enter PIN to deactivate.” Also by way of example, monitor 12 may display theft deterrence program deactivation pane 70 shown in FIG. 7.

In a step 97, process 80 verifies the user-entered PIN. In response to the user-entered PIN matching the pin stored in monitor 12, process 80 proceeds to step 94 and deactivates the theft deterrence program. In response to no matching PIN, process 80 proceeds to step 98, in which monitor 12 enters the theft deterrence mode.

In accordance with one embodiment of the present invention, monitor 12 is inoperable in the theft deterrence mode. In a preferred embodiment, the inoperable mode powers down the display once the predetermined timer value has elapsed. In order to continue display usage, the user needs to either re-enter the PIN or completely cycle the power to monitor 12. Entering the PIN deactivates theft deterrence mode and allows monitor 12 to operate in a normal fashion until it is disconnected from the power and host computer again. Completely cycling the power to monitor 12 resets the countdown timer. In accordance with another embodiment of the present invention, monitor 12 in the theft deterrence mode is still operable but with significantly deteriorated performance. In accordance with a specific embodiment, monitor 12 presents a skewed image in the theft deterrence mode. This can be accomplished by inverting the color ramps of the LCD or setting the display to gray scale.

In accordance with a preferred embodiment of the present invention, the theft deterrence program can be deactivated or disabled even if the user forgets the PIN or if there is an unforeseen problem when saving the theft deterrence information to monitor 12. In one embodiment, the theft deterrence program supports a backdoor into the monitor 12 to reset the PIN. The end-user can register monitor 12 and PIN on a manufacturer, vendor or third party web site. In another embodiment, the user can use a password to access and disable theft deterrence program if the PIN is forgotten.

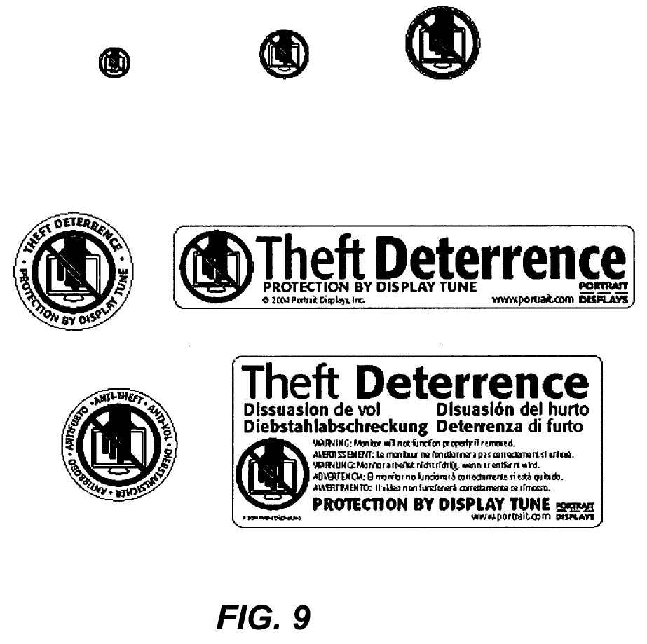

The effectiveness of theft deterrence can be further accomplished by combining theft deterrence process 80 described herein above with reference to FIG. 8 with various labels attached to monitor 12 and host computer 11 in computer system 10 shown in FIG. 1. The labels indicate computer system 10 and specifically monitor 12 being protected by the theft deterrence program. The labels can also provide trademark protection to the theft deterrence program. FIG. 9 illustrates, by way of examples, several theft deterrence labels that can be attached to computer system 10.

By now it should be appreciated that a theft deterrence process has been provided. In accordance with the present invention, the system includes a theft deterrence program installed on a peripheral device, e.g., a monitor, and a host computer couple the peripheral device. In operation, the theft deterrence program is in a deactivated state until a triggering event. For example, the theft deterrence program may be in the deactivated state as long as the peripheral device is connected to the host computer and to the power source. Once the peripheral device is disconnected from the power source and the host computer, the theft deterrence program enters an activated state when it is powered up again. In the activated state, a timer starts to countdown. If the program is not deactivated within a predetermined time period, the theft deterrence program enters a theft deterrence mode that disables or significantly deteriorates the function of the peripheral device. Connecting the peripheral device to an authorized host computer or entering a PIN before the countdown time elapses can deactivate the theft deterrence program. The deactivated theft deterrence program allows the normal operation of the peripheral device.

In accordance with the present invention, an unauthorized disconnection and move of a peripheral device will render the device inoperable or substantially affect its performance. The theft deterrence method and system in accordance with the present invention is specially beneficial in deterring the theft of LCD flat panel monitors that are light in weight and compact in size. Other peripheral devices, e.g., CRT monitors, printers, etc., can also benefit from the theft deterrence system of the present invention.

While various embodiments of the present invention have been described with reference to the drawings, these are not intended to limit the scope of the present invention, which is set forth in the appending claims. Various modifications of the above described embodiments can be made by those skilled in the art after browsing the specification of the subject application. These modifications are within the scope and true spirit of the present invention.

1. A process for deterring an unauthorized move of a device, comprising:
detecting a triggering event indicating the unauthorized move of the device;
starting a time countdown;
terminating the time countdown in response to a valid authorization code; and
entering a theft deterrence mode in response the time countdown elapsing a predetermined time period.

2. The process of claim 1, detecting a triggering event including detecting a disconnection of the device from a host device.

3. The process of claim 1:
detecting a triggering event including detecting a power shutdown of the device; and
starting a time countdown including starting the time countdown in response to a power up to the device.

4. The process of claim 1, further comprising:
installing a theft deterrence program on the device; and
enabling the theft deterrence program on the device.

5. The process of claim 4, enabling the theft deterrence program on the device including storing a personal identification number (PIN) in the device.

6. The process of claim 5, further comprising entering the PIN to disable the theft deterrence program.

7. The process of claim 1, terminating the time countdown in response to a valid authorization including:
comparing a first personal identification number (PIN) in the device with a second PIN in a host device; and
terminating the time countdown in response to the first PIN matching the second PIN.

8. The process of claim 1, terminating the time countdown in response to a valid authorization code including:
requesting an input of a first personal identification number (PIN);
comparing the first PIN with a second PIN stored in the device; and
terminating the time countdown in response to the first PIN matching the second PIN.

9. The process of claim 1, entering a theft deterrence mode including rendering the device inoperable.

10. The process of claim 1, entering a theft deterrence mode including substantially deteriorating a performance of the device.

11. A method for deterring an unauthorized move of a computer peripheral device, comprising:
coupling the computer peripheral device to a host computer;
installing a theft deterrence program on the computer peripheral device and on the host computer;
enabling the theft deterrence program by entering a password;
storing the password in the computer peripheral device;
detecting a disconnection of the computer peripheral device from the host computer;
activating the theft deterrence program to start a clock countdown in response to the computer peripheral device being disconnected from the host computer and connected to a second host computer;
terminating the time countdown in response to a password in the second host computer matching the password stored in the computer peripheral device; and
entering a theft deterrence mode in response to the time countdown elapsing a predetermined time period.

12. The method of claim 11, wherein activating the theft deterrence program includes activating the theft deterrence program further in response to the computer peripheral device being disconnected from a first power source and subsequently connected to a second power source.

13. The method of claim 11, further comprising:
requesting an input of a password at the second host computer;
comparing the input password with the password stored in the computer peripheral device; and
terminating the time countdown in response to the input password matching the password stored in the computer peripheral device.

14. The method of claim 11, further comprising entering a password matching the password stored in the computer peripheral device to disable the theft deterrence program.

15. The method of claim 11, wherein entering a theft deterrence mode includes rendering the device inoperable.

16. A theft deterrence system for deterring an unauthorized moved of a computer peripheral device coupled to a host computer comprising a theft deterrence program on the computer peripheral device and on the host computer, the theft deterrence program including the steps of:
detecting a disconnection of the computer peripheral device from the host computer;
entering an activation state to start a clock countdown in response to the computer peripheral device being disconnected from the host computer and connected to a second host computer;
entering a deactivation state and terminating the time countdown in response to a code in the second host computer matching a code stored in the computer peripheral device; and
entering a theft deterrence mode in response to the time countdown elapsing a predetermined time period.

17. The theft deterrence system of claim 16, wherein the step of entering an activation state includes entering the activation state further in response to the computer peripheral device being completely powered down and subsequently powered up.

18. The theft deterrence system of claim 16, the theft deterrence program further including the steps of:
requesting an input of a code at the second host computer;
comparing the input code with the code stored in the computer peripheral device; and
entering the deactivation state in response to the input code matching the code stored in the computer peripheral device.

19. The theft deterrence system of claim 16, the theft deterrence program further including the step of entering a disabled state in response to a user request with an input code matching the code in the computer peripheral device.

20. The theft deterrence system of claim 16, wherein entering a theft deterrence mode includes significantly affecting a performance of the computer peripheral device.
